(19) United States
(12) Patent Application Publication
(10) Pub. No.: US 2015/0098455 A1
(43) Pub. Date: Apr. 9, 2015

(54) WiFi Enabled Wide Area Automation System

(71) Applicant: Darren William Fritsch, North Potomac, MD (US)

(72) Inventor: Darren William Fritsch, North Potomac, MD (US)

(21) Appl. No.: 13/999,421

(22) Filed: Oct. 9, 2013

(51) Int. Cl. H04L 12/28; H04W 76/00; H04W 84/12

(52) U.S. Cl. CPC H04L 12/2816; H04W 84/12; H04W 76/00; H04L 2012/2847
USPC 370/338

(57) ABSTRACT

Disclosed is a Wi-Fi enabled wide area automation system. The system includes an application installed in a handheld wireless communication device for wireless controlling of the at least one appliance by accessing a specific preset hypertext markup language (HTML) page. A microcontroller server communicates with the application to control the at least one appliance. The microcontroller server is configured to operate in a web server mode using TCP/IP stack. A Wi-Fi router connected with the microcontroller server using a wireless local area network (WLAN) enables the microcontroller server to communicate with the handheld wireless communication device. A relay controls the at least one appliance based on a signal from the microcontroller server. A liquid-crystal display (LCD) displays a plurality of statuses of the microcontroller server.

### BACKGROUND

The present invention relates to controlling appliances and more particularly to a method and system for remotely controlling appliances using a portable wireless communication device.

Home automation networks have become increasingly popular. Home automation networks can incorporate diverse elements, such as security system components, environmental controls, lighting controls, and audio/visual equipment. While users enjoy the ability to control a wide variety of components, the necessary remote control devices can become very complex. With complexity comes cost and difficulties in upgrading and maintaining the controls.

Current technology allows conventional appliances to be controlled manually and automatically. Although these conventional appliances are useful, a user must be in proximity to many of these conventional appliances in order to control the conventional appliances. Some conventional appliances, such as audio or video equipment can be controlled using a conventional remote control. The conventional remote control can provide commands to the conventional appliance. If the conventional appliance receives the command, the conventional appliance will perform the command. However, the user still relies on the conventional appliance's display to obtain data about the status of the conventional appliance or determine whether the command provided via the remote control was performed.

It is common practice that household appliances are set to perform only functions suitable for their respective purposes independently of the other appliances. Recently, techniques associated with the remote control of household appliances by a user have been developed continuously. It is common that the remote control of household appliances is carried out through wired/wireless communication means. This generalized remote control technique is disadvantageous in that the existing systems are very costly and cannot be employed for controlling all the appliances. Some universal remote controls can be programmed to learn new control codes. For example, the devices can be connected to the Internet through a computer in order to download new control codes for new devices. Other devices can be programmed with new codes using the original remote control provided with the device. Although devices can be updated to accommodate new system components, reprogramming the remote control is cumbersome for a user. When a large number of devices are to be controlled by the remote control device, the remote control can become quite complex. Some remote control devices include a very large number of buttons, which can be visually undesirable as well as drive up costs for the packaging of the device.

In addition, most consumers have no knowledge on the energy consumption levels of various household appliances and electrical devices which consume electricity and generally rely on common sense to conserve electricity use. With the advent of home automation technologies both in the wireless and power-line based areas, an increasing number of devices and technologies are being offered to the consumers to perform smart energy management in a consumer household. Such technologies include, for example, Insteon™, Z-Wave®, ZigBee®, Echelon®, and the like. However, all of these products operate strictly within the realm of the technology they are based on, and tend to operate independently and passively follow the protocol dictated by the technology to perform a fixed function. In addition, these technologies require higher cost to implement.

Thus, there exists a need for a system and method for remotely controlling an appliance. It would be desirable if the system and method could control a plurality of appliances using a single wireless controller. Moreover, the needed system would be cost effective, simple, user-friendly and universally employable for controlling most of the devices having different load capacities and for controlling a plurality of devices simultaneously. The present invention addresses such a need.

### SUMMARY

The present invention is a method and system for remotely controlling a plurality of appliances through wireless communication devices. In one aspect, the method and system provide a portable wireless communication device for remotely controlling appliances. The system is a Wi-Fi enabled wide area automation system. The system includes a mobile application installed in a handheld wireless communication device or a smartphone for wireless control of the at least one appliance by accessing a specific preset hypertext markup language (HTML) page stored in a web server. A microcontroller server communicates with the application to control the at least one appliance. The microcontroller is located at the vicinity of the appliance to be controlled. The HTML page for controlling the appliances is stored in the microcontroller server and can be accessed wirelessly. The microcontroller server is configured to operate in a web server mode using TCP/IP stack. A Wi-Fi router connected with the microcontroller server using a wireless local area network (WLAN) enables the microcontroller server to communicate with the handheld wireless communication device over the wireless network. A relay controls the power input and thereby controlling at least one appliance based on a signal from the microcontroller server. A liquid-crystal display (LCD) displays a plurality of statuses of the microcontroller server.

The stages for the working of the system include starting an android/iOS/windows phone app and scanning for nearby Wi-Fi network in the vicinity. If the network is password protected, it will prompt on the screen. When proper pairing is done, successful connection between the app and the network is indicated by ‘CONNECTED’ status in app & green indicator on the app screen. A button “LOAD ON/OFF” will show on the screen. Clicking on it will send instruction to the MCU Server. Based on the instruction the appliance is turned on or off. If the Appliance is turned off, the HTML page will show a button “Turn On” or if the appliance is turned on, the app will show “Turn Off”. On clicking the button accordingly, the MCU server installed in the appliance and connected to the Wi-Fi router in its range using WLAN will enable or trip off the power circuit of the appliance.

Other objects and advantages of the embodiments herein will become readily apparent from the following detailed description taken in conjunction with the accompanying drawings.

### BRIEF DESCRIPTIONS OF THE DRAWINGS

FIG. 1 is a schematic showing the basic elements of a Wi-Fi enabled wide area automation system in accordance with the present invention.

FIG. 2 is a schematic block diagram of a handheld mobile communication device for controlling a plurality of appliances in accordance with the present invention.

FIG. 3 is a schematic block diagram of a multipoint control unit (MCU) server according to a preferred embodiment of the present invention.

FIG. 4 illustrates a flow diagram of an exemplary method for controlling the plurality of appliances according to a preferred embodiment of the present invention.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

It is desirable to control the conventional appliance from a distance especially operating the device or appliance with a user is not in the vicinity of the appliance. The preferred embodiment of the present invention depicts the Wi-Fi enabled wide area automation system for remotely controlling an appliance. The system includes a remote control in the form of a handheld wireless communication device such as a smartphone. By way of example, the communication network of system includes one or more networks such as a data network (not shown), a wireless network (not shown), or any combination thereof. It is contemplated that the data network may be any local area network (LAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The handheld wireless communication device is any type of mobile terminal, or portable terminal including a mobile handset, station, unit, device, multimedia computer, multimedia tablet, Internet node, communicator, laptop computer, notebook computer, netbook computer, tablet computer, Personal Digital Assistants (PDAs), or any combination thereof, including the accessories and peripherals of these devices, or any combination thereof. It is also contemplated that the handheld wireless communication devices can support any type of interface to the user such as “wearable” circuitry, etc.

Processes executing on various devices, often communicate using the client-server model of network communications, widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host on which the process operates. Similarly, the term “client” is conventionally used to refer to the process that makes the request, or the host on which the process operates. As used herein, the terms “client” and “server” refer to the processes, rather than the hosts, unless otherwise clear from the context. A well-known client process available on handheld wireless communication devices connected to a communications network is a World Wide Web client (called a “web browser,” or simply “browser”) that interacts through messages formatted according to the hypertext transfer protocol (HTTP) with any of a large number of servers called World Wide Web (WWW) servers that provide web pages. In the illustrated embodiment, the handheld wireless communication device includes an application, a browser and a user interface (UI). In some embodiments, one or more of appliances are controlled by the handheld wireless communication device though the browser or the application. In some embodiments, one or more of appliances are controlled by the user of handheld wireless communication device though a corresponding special software application.

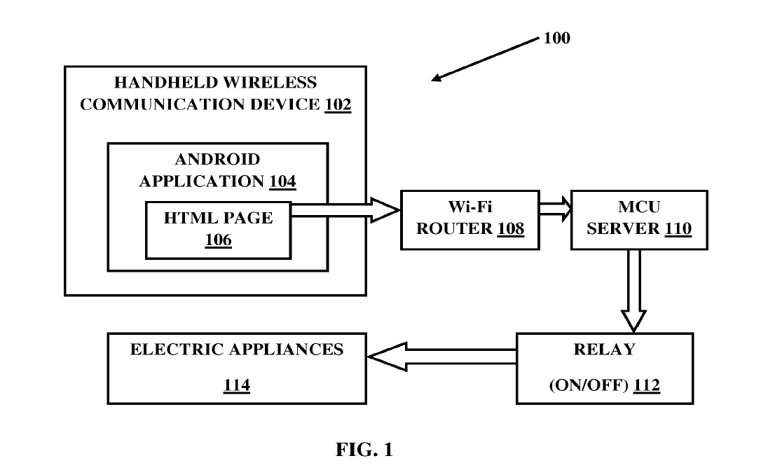

Referring first to FIG. 1, depicted is a schematic representation of the basic elements of a Wi-Fi enabled wide area automation system 100 in accordance with the present invention. The handheld wireless communication device 102 includes an appliance control program which is the smartphone application 104 and a wireless communication module such as Wi-Fi module for communicating with the appliances 114. The appliance control program allows the conventional appliance 114 to perform operations based on commands provided to the conventional appliance from the handheld wireless communication device 102. The architecture of the handheld wireless communication device 102 includes an operating system, device drivers, a screen driver, and a general purpose control program which resides in the memory and is used by a processor. The device drivers include a driver for the wireless communication port or a Wi-Fi module. The screen driver preferably controls the touch screen used as the display to display a user interface of an application 104. The application 104 is capable of controlling the electric appliances 114 through the mechanism discussed below. However, the application 104 need not be specifically tailored to a particular appliance 114 or a particular type of appliance 114. Instead, using the method and system in accordance with the present invention, the application 104 allows the handheld wireless communication device 102 to remotely access the data and to control a wide variety of appliances 114.

An embodiment of the present invention provides a cost effective Wi-Fi enabled wide area automation system 100. The Wi-Fi enabled wide area automation system 100 includes the two components, the first one is a controller for controlling the operation of the wide variety of appliances 114 and the second device is a handheld wireless remote controller with embedded application 104 for signaling the controller. The controller used in the embodiment of the present invention is a microcontroller server 110. An AVR processor is designed to be used as the microcontroller server 110 for receiving a user input from the handheld wireless communication device 102. The micro controller server i.e. the MCU server 110 monitors the user input from the handheld wireless communication device 102 and may either turn on or turn off at least one electric appliance 114 associated with the MCU server 110. The MCU server 110 is a single on chip computer which includes number of peripherals like RAM, EEPROM, Timers etc., required to perform some predefined task i.e. for wireless reception of the signals from the handheld wireless communication device 102 thereafter controlling the at least one electric appliance 114. The AVR processor or the MCU server 110 is configured as the web server using a TCP/IP stack. Ethernet connectivity can be provided with the MCU server 110. An HTML page 106 configured with a static IP is stored within the MCU server 110 and can be accessed by an application or form a web browser by providing the static IP address. The HTML page 106 includes the configurations for controlling the relay associated with the electric appliance 114. A parallel LCD display is provided with the microcontroller to display a plurality of information related to the operation of the electric appliance 114. The LCD display will show the plurality of statuses of the server. The Wi-Fi router 108 is connected with the MCU server 110 using wireless local area network (WLAN) which will communicate with the handheld wireless communication device 102 or the smartphone. The smartphone includes the application 104 and from the application the HTML page 106 can be reached when the smartphone is connected to a Wi-Fi network. The user can access the HTML page 106 through the application and can control a variety of home appliances 104 which are connected to the MCU server 110.

In an embodiment of the present invention the Wi-Fi enabled wide area automation system 100 is operated from the application 104 running on an android or iOS or windows phone devices. Once the application 104 is launched from the handheld wireless communication device 102, the android/iOS/windows phone app is started and scanned for nearby Wi-Fi network in the vicinity. If the network is password protected, it will prompt on the screen. When proper pairing is done, successful connection between the app and the network is indicated by ‘CONNECTED’ status in app & green indicator on the app screen. A button “LOAD ON/OFF” will show on the screen. Clicking on it will send instruction to the MCU Server 110. Based on the instruction the Appliance is turned on or off. If the Appliance is turned off, the app screen will show a button “Turn On” or if the appliance is turned on, the app will show “Turn Off”. On clicking the button accordingly, the MCU server 110 will enable or trip off the power circuit of the appliance. The MCU server 110 installed in the appliance must be connected to a Wi-Fi router in its range using WLAN.

The Wi-Fi enabled wide area automation system 100 communicates with a multipoint control unit (MCU) server 110 through an application 104 loaded into a handheld wireless communication device 102. The software application 104 installed in the handheld wireless communication device 102 may be an android application or iOS or windows phone application. The application 104 when launched is directed through a web browser 126 which in turn directs to a preloaded HTML page 106, that can be accessed from any location having a Wi-Fi connectivity or internet connectivity using the handheld wireless communication device 102. The

HTML page 106 includes fields for starting, stopping or controlling a plurality of electrical appliances 114 associated with the MCU server 110. A Wi-Fi router 108 is installed with the MCU server 110 and connected to a wireless local area network (WLAN). A user can control the operation of the plurality of electrical appliances 114 associated with the MCU server 110 by accessing the HTML page 106 embedded within the MCU server 110. The HTML page 106 embedded within the MCU server 110 is configured to control the plurality of electrical appliances 114 in home and in office, such as by starting, stopping or by dimming, in case of lights. The MCU server 110 is connected to a relay 112 which switch on and switch off the plurality of electrical appliances 114 by enabling and disabling the power supply to the plurality of electrical appliances 114. An ordinary browser application implemented with the MSN Explorer, Microsoft Internet Explorer, Netscape or Firefox or chrome can access the HTML page 106 embedded within the MCU server 110 for accessing the control of the plurality of electrical appliances 114. The HTML page 106 embedded within the MCU server 110 include an embedded page that exists at a specific static IP-address of a remote site. The user can access the embedded page that exists at the specific static IP-address for controlling the electrical appliances 114.

The MCU server 110 connected to a wireless network using the Wi-Fi router 108 with WLAN connected to a security firewall. The security firewall provides protection of the MCU server 110 from accidental and/or malicious attacks that could disrupt the operation or control of the electrical appliances 114. The application 104 converts software commands communicated in the form of TCP/IP data packets into signals for the MCU server 110 can use. For example, messages can be sent from the application 104 that will allow the MCU server 110 to operate the relay 112 to activate on-off switches in the electric power-distribution part of the electrical appliances 114. In an embodiment of the present invention, the MCU server includes a few optional buttons for menu related operations.

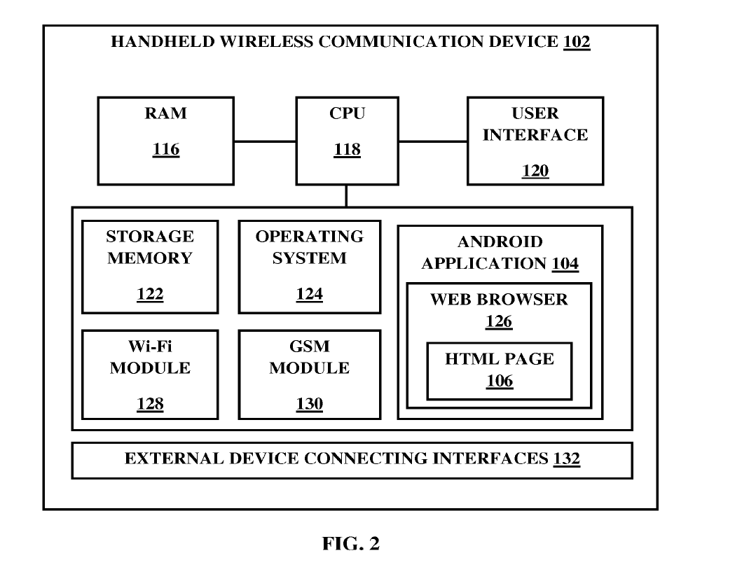

FIG. 2 is a schematic block diagram of the handheld wireless communication device 102 for controlling the plurality of appliances 114 in accordance with the present invention. The handheld wireless communication device 102 includes an assembled main body and a keyboard structure having a plurality of keys. In an embodiment, the handheld wireless communication device 102 having a touch screens display to view output and for giving input to the Wi-Fi enabled wide area automation system 100. The handheld wireless communication device 102 includes multiple components such as a processor or central processing unit (CPU) 118 that controls the operations of the handheld electronic communication device 102. Communication functions, including data and voice communications, are performed through a communication subsystem. Data received by the handheld wireless communication device 102 is decompressed and decrypted by a decoder. The communication subsystem receives messages from and sends messages to a wireless network through a Wi-Fi module 128 or a GSM module 130. The wireless network may be any type of wireless network, including, but not limited to, data-centric wireless networks, voice-centric wireless networks, and dual-mode networks that support both voice and data communications over the same physical base stations. The handheld wireless communication device 102 is a battery-powered device and includes a battery interface for receiving one or more rechargeable batteries.

The CPU 118 also interacts with additional subsystems such as a Random Access Memory (RAM) 116, a flash storage memory 122, a first display screen with a touch-sensitive overlay showing a user interface 120, the first display screen with a touch-sensitive overlay connected to an electronic controller that together comprise a touch-sensitive display, an optional keypad, an auxiliary input/output (I/O) subsystem including an external device connecting interface 132 which may further include a data port, a speaker, a microphone, a navigation device, short-range and data communication device including the Wi-Fi module 128 and the GSM module 130 and other device subsystems. The handheld wireless communication device 102 also includes an operating system 124 and software components that are executed by the processor 118 and are typically stored in a persistent store such as flash memory or storage memory 122.

In an embodiment, additional applications may be loaded onto the handheld wireless communication device 102 through the wireless network, the auxiliary I/O subsystem having the external device connecting interfaces 132, the short-range communications subsystems such as using the Wi-Fi module 128, or any other suitable device subsystem. The operating system 124 installed in the handheld wireless communication device 102 enables controlling of all the above said subsystems. The processor 118 interacts with the touch-sensitive overlay showing the user interface 120 via an electronic controller. Information, such as text, characters, symbols, images, icons, and other features that may be displayed or rendered on a handheld wireless communication device 102, are displayed on the display device, on the first display screen via the processor 118. A software application installed in the handheld wireless communication device 102 enables wireless controlling of a plurality of appliances and devices at home or office or any desired location. The software application 104 installed in the handheld wireless communication device 102 may be an android application or iOS or windows phone application. The MCU server 110 will act as WEB- SERVER using an Ethernet Controller and TCP/IP stack. The HTML page 106 is already stored in the application layer of the TCP/IP stack. The server has a specific static IP address. Wi-Fi is configured as wireless LAN to make the CLIENT-SERVER network wireless. Any mobile/tablet etc. with Wi-Fi can be used to operate the LOAD or the electrical appliances 104. The user has to open a customized browser app or any browser to access the HTML page 106. In the URL the user have to put the Server URL. Then the user will get the basic HTML page 106 stored in the server. Through the basic HTML page 106 the user can operate the LOAD. The application 104 when launched is directed through a web browser 126 and a preloaded HTML page 106 can be accessed. The HTML page 106 includes fields for starting, stopping or controlling the plurality of electrical appliances 114. Upon receiving wireless signals from the handheld wireless communication device 102, the web server will signal to operate the relay 112 according to the command from the user. Thus the power input to the electrical appliances 114 can be controlled by using the Wi-Fi enabled wide area automation system 100.

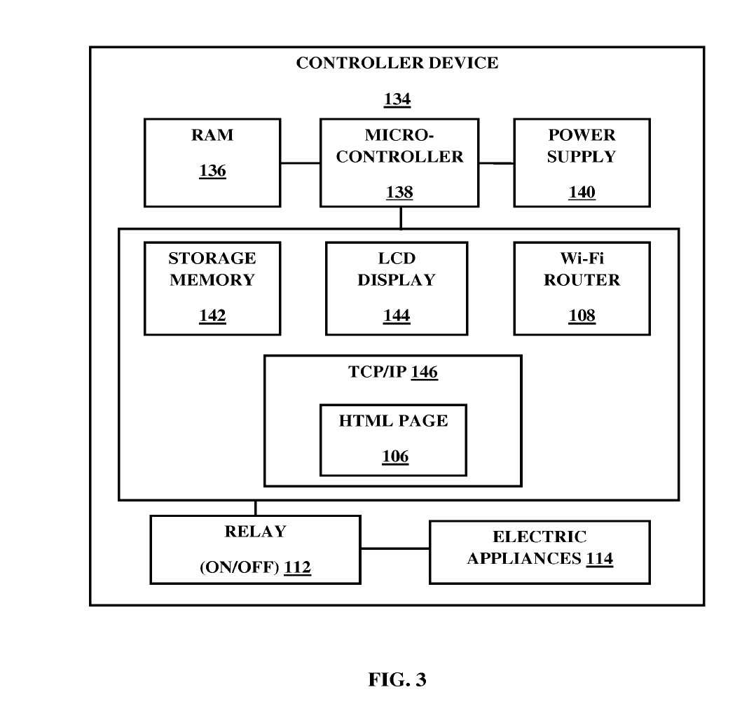

FIG. 3 is a schematic block diagram of the controller device 134 associated with the electric appliances 114 according to an embodiment of the present invention. The microcontroller 138 is an AVR processor which is capable of operating as a web server. The AVR processor or the microcontroller 138 is configured as the web server or the MCU server for controlling the plurality of electrical appliances 114 using a TCP/IP stack 146. Ethernet connectivity is provided with the MCU server by attaching an Ethernet connectivity chip with the microcontroller 138. The microcontroller 138 includes EEPROM having a limited storage capacity. The HTML page 106 configured with a static IP is stored within the EEPROM of the microcontroller 138 and can be accessed by the application or form any web browser by providing the uniform resource locator (URL) of the static IP address. The HTML page 106 includes the configurations for controlling the relay 112 associated with the plurality of electric appliances 114. The power input to the plurality of electric appliances 114 are independently controlled by one or more relays 112. Based on the user input through the HTML page 106 from the application 106 running in the smartphone, the relay 112 is actuated. The LCD display 144 provided with the microcontroller 138 display a plurality of information related to the operation of the electric appliance 114. The LCD display will show the plurality of statuses of the server. The Wi-Fi router 108 with the wireless local area network (WLAN) will communicate with the handheld wireless communication device 102 for receiving inputs from the user. The HTML page 106 is stored in the EEPROM storage memory 142 of the microcontroller 138. The microcontroller may include a RAM 136, which may be an erasable memory for dynamically loading the webpage during the execution of the HTML page 106. The controller device 134 is usually powered by a DC power supply 140 of suitable rating and ensures continuous and hassle free operation of the system 100. The controller device 134 also includes several keys for manual control of the device and the operation of the keys can be displayed on the LCD display 144.

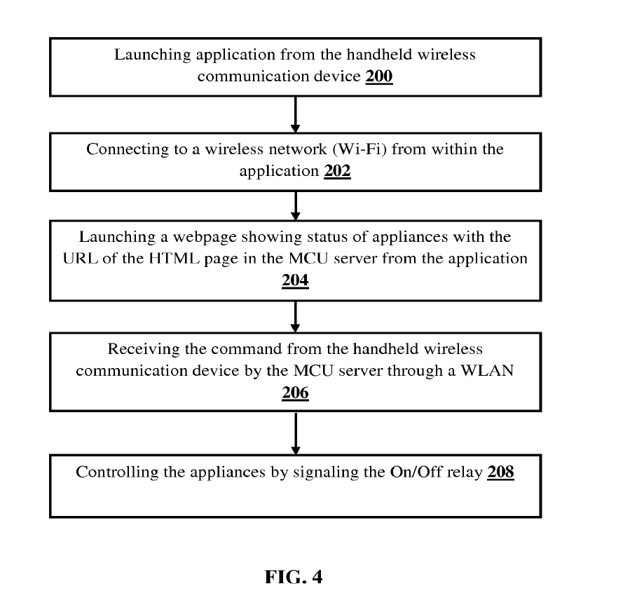

FIG. 4 illustrates a flow diagram of an exemplary method for controlling the plurality of electric appliances 114 according to a preferred embodiment of the present invention. The stages for the working of the system 100 includes starting an android/iOS/windows phone app and scanned for nearby Wi-Fi network in the vicinity. If the network is password protected, it will prompt on the screen. When proper pairing is done, successful connection between the app and the network is indicated by ‘CONNECTED’ status in app & green indicator on the app screen. A button “LOAD ON/OFF” will show on the screen. Clicking on it will send instruction to the MCU Server. Based on the instruction the appliance is turned on or off. If the Appliance is turned off, the HTML page will show a button “Turn On” or if the appliance is turned on, the app will show “Turn Off”. On clicking the button accordingly, the MCU server installed in the appliance and connected to the Wi-Fi router in its range using WLAN will enable or trip off the power circuit of the appliance.

The method is preferably used at the commencement up to the final control and interaction between the handheld wireless communication device 102 and the appliances 114. The user of the handheld wireless communication device 102 launches the software application 104 installed in the device, as shown in step 200. The software application 104 enables Wi-Fi of the handheld wireless communication device 102 and scans for any accessible wireless networks as shown on block 202. After connecting to a Wi-Fi network, the application 104 can be operated to control the desired electrical appliance 114. The web browser of the application 104 connects to the URL of the HTML page 106 having a static IP stored in the MCU server 134 as in block 204. The user can now change any desired options provided in the HTML page 106 for controlling the desired electric appliance 114. The data is sent to the MCU server 134 through the wireless network to which the handheld wireless communication device 102 is connected. The MCU server 134 receives the command from the handheld wireless communication device 102 through a WLAN as shown in block 206. Finally, as in block 208, the control relay is activated by the microcontroller and switches on or switches off the desired electrical appliance 104 by controlling the power input.

According to one embodiment of a method for controlling the appliances 114 using the handheld wireless communication device 102, Zigbee protocol can be used. Zigbee protocol can be used for controlling a mesh structure covering large civil establishments. The user using the handheld wireless communication device 102 controls the appliances 114 through the wireless communication network. The communication may be passed as a command, a query, or other information. Via step 420, the appliance 120 then executes the command or retrieves the information requested in the query. The appliance 114 may provide a response to the MCU server 134.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

We claim:

1. A wide area automation system having a handheld wireless communication device for wireless control of at least one appliance, the system comprising:
a control application installed in the handheld wireless communication device for wireless control of the at least one appliance by accessing a specific preset hypertext markup language (HTML) page;
at least one microcontroller server capable to communicate with the control application to control the at least one appliance, the at least one microcontroller server being configured to operate in a web server mode using TCP/IP stack;
at least one relay for controlling the at least one appliance based on a signal from the microcontroller server;
a Wi-Fi router connected with the at least one microcontroller server using a wireless local area network (WLAN) enabling the microcontroller server to communicate with the handheld wireless communication device; and
a liquid-crystal display (LCD) for displaying a plurality of statuses of the microcontroller server;
whereby the handheld wireless communication device controls the at least one appliance by accessing the HTML page stored within the microcontroller server.
